(19) United States
(12) Patent Application Publication
(10) Pub. No.: US 2026/0318666 A1
(43) Pub. Date: Oct. 15, 2026

(54) DEVICE(S) FOR MEASURING ENERGIZED ELECTRICAL CONDUCTORS AND RELATED SYSTEMS AND METHODS

(71) Applicant: American Electric Power Company, Inc., Columbus, OH (US)

(72) Inventors: Joel P. Clouse, Fort Wayne, IN (US); Isaac T. DeWitt, Markle, IN (US); Luke A. Federspiel, Fort Wayne, IN (US)

(21) Appl. No.: 19/573,032

(22) Filed: Mar. 20, 2026

Related U.S. Application Data
(60) Provisional application No. 63/787,490, filed on Apr. 11, 2025.

(51) Int. Cl. G01B 3/42; G01B 5/08; G01D 11/16; H01B 3/42; H01B 3/44

(52) U.S. Cl. CPC G01B 3/42; G01B 5/08; G01D 11/16; H01B 3/423; H01B 3/448

(57) ABSTRACT

A device for measuring energized electrical conductors is described. The device includes a body and multiple slots. The slots are dimensioned to receive and measure a conductor at a substation. The body is configured to be attached to a pole that is held by an operator for positioning the device at a conductor. The size of each slot corresponds to the size of a conductor; thus, the slots may be positioned at the conductor to determine the size of the conductor. The body may include one or more inserts.

### CROSS-REFERENCE TO RELATED APPLICATIONS

This non-provisional patent application claims priority to U.S. Provisional Application No. 63/787,490, filed on Apr. 11, 2025, the disclosure of which is hereby incorporated by reference in its entirety as if fully recited herein.

### TECHNICAL FIELD

Embodiments of the present disclosure relate generally to analyzing electrical conductors. More particularly, the present disclosures relate to a device for measuring the physical size of energized electrical conductors (also referred to herein as a Conductor Size and Verification Tool, or CSVT) used in substation facilities as well as related systems and methods. In one example, without limitation, the device includes a body defining one or more slots. The body may be configured for attachment to a pole that may be held by an operator. Each slot may be configured to measure a conductor, wherein the diameter of the slot may correspond to the diameter of the conductor. The body may be configured to receive one or more inserts adapted to adjust the size of slots at the CSVT.

### BACKGROUND AND SUMMARY OF THE INVENTION

Measuring the dimensions of conductors at an energized substation is important for ensuring substation safety and equipment reliability, as well as for ensuring compliance with regulatory frameworks (e.g., Reliability First mandates). For example, an improperly sized conductor may increase the risk of issues such as faults, shock hazards, overheating equipment, fire hazards, equipment damage, some combination thereof, or the like. Traditionally, measuring the dimensions of conductors within an energized substation has presented significant challenges that render making such measurements exceedingly difficult or even unfeasible.

One known technique for measuring the dimensions of conductors involves a contour gage. A contour gage includes flexible pins that may conform to the shape of an object, which may allow a user to capture an outline of the object. An issue with the contour gage technique includes that significant modifications are required for said technique to be safe with live-line applications, and for the contour gage to reach elevated conductors within a substation. Another issue is the contour gauge includes moving components that may hinder the effectiveness of the gauge by hindering its ability to envelop a conductor's shape. This limitation often results in measurements that are not precise and/or are inaccurate. Even a minor error in a conductor size measurement may substantially undermine the reliability of the conductor, and may negate compliance with regulatory standards.

Another known technique for measuring the dimensions of conductors involves a conductor gauge. A conductor gauge may be designed to attach to a live-line tool and slide over the conductor for size assessment. Although this technique may provide a more direct and accurate means of measuring a conductor compared to the contour gauge, this technique has significant limitations. For example, the conductor gauge is restricted to measuring only up to a maximum conductor size, which reduces its versatility and effectiveness within substations that may feature conductors of differing sizes. Additionally, known conductor gauges are made from conductive aluminum. This may present safety concerns to those using a conductor gauge in an energized environment (e.g., a user may be harmed if the gauge contacts live components).

An alternative known technique for measuring the dimensions of conductors involves de-energization of substation equipment, followed by thorough testing to ensure that the equipment is indeed deenergized. Once confirmed, grounding may be installed to facilitate manual measurements of conductors using a variety of existing tools, such as calipers and/or conductor slide gauges. An issue with this technique includes that the technique requires extensive preplanning, significant labor, and careful coordination with other projects, as well as scheduled outages. The de-energization of a Bulk Electric System (BES) may have far-reaching negative implications (e.g., may affect remote locations, distribution customers, and other utilities).

As the known techniques are either ineffective for achieving a required level of accuracy and safety for modern substations, and/or are highly disruptive, there is an urgent unmet need for a more reliable, safer, and less disruptive technique for measuring conductor sizes with higher accuracy.

In view of this, it is beneficial to have a device for measuring energized electrical conductors as described herein. An exemplary device provides for reliable and safe verification of the dimensions of engineering drawings with the physical conditions observed within a substation.

According to the present disclosures in one aspect, a Conductor Size and Verification Tool includes a solid body defining one or more slots. The body may be configured for attachment to a pole. The body and/or pole may be configured to not transmit current (to promote safety for use of the CSVT with an energized system). For example, the body and/or pole may be comprised of one of more insulating materials. Each slot may be configured to measure a conductor, wherein the diameter of the slot may correspond to the diameter of the conductor. The body may be configured to receive one or more inserts adapted to adjust the size and/or number slots at the CSVT. An exemplary CSVT may provide a definitive means of determining energized conductor sizes with high precision while ensuring the safety of the operator. By facilitating accurate conductor measurements, an exemplary CSVT helps ensure compliance of substations with regulatory standards, and enhances the overall reliability of an electric utility system.

One advantage of an exemplary CSVT is that the CSVT may streamline the conductor verification process by enabling conductor verification measurements to be taken while a BES remains energized (as opposed to having the disruption caused by deenergizing a BES, such as interrupted service). Another advantage is that the CSVT may improve measurement accuracy and reduce the likelihood of issues linked to human error with operators handling live equipment, and/or exposing themselves to risks (even when the substation is deenergized).

The CSVT may comprise a single body. Optionally, the CSVT may comprise a plurality of bodies with various size and/or shaped slots. The plurality of bodies may optionally be configured for interlocking and may be arranged into a stack, such as by retaining clips (also referred to herein as “retainer clips”) which are configured to engage at least some of the stacked bodies.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an exemplary device for measuring energized electrical conductors;

FIG. 2 illustrates a perspective view of another exemplary device for measuring energized electrical conductors, wherein the device is positioned at a conductor;

FIG. 3 illustrates a perspective view of the device of FIG. 2 having an insert removed therefrom;

FIG. 4 illustrates a perspective view of yet another exemplary device for measuring energized electrical conductors;

FIG. 5 illustrates a cross sectional perspective view of the device of FIG. 1 positioned at a conductor;

FIG. 6 illustrates a perspective view of the device of FIG. 1 positioned at a conductor;

FIG. 7 illustrates a perspective view of a stack of exemplary devices for measuring energized electrical conductors;

FIG. 8 illustrates the device of FIG. 1 with a plurality of inserts positioned at the device;

FIG. 9 illustrates another perspective view of the device of FIG. 2;

FIG. 10 illustrates a perspective view of yet another exemplary device for measuring energized electrical conductors;

FIG. 11 illustrates a perspective view of yet another exemplary device for measuring energized electrical conductors;

FIG. 12 illustrates a perspective view of yet another exemplary device for measuring energized electrical conductors;

FIG. 13 illustrates a perspective view of yet another exemplary device for measuring energized electrical conductors;

FIG. 14 illustrates a perspective view of yet another exemplary device for measuring energized electrical conductors;

FIG. 15 illustrates a perspective view of yet another exemplary device for measuring energized electrical conductors;

FIG. 16 illustrates a perspective view of another stack of exemplary devices for measuring energized electrical conductors;

FIG. 17 illustrates a cross-sectional view of the stack of FIG. 16;

FIG. 18 illustrates a prior art conductor gauge;

FIG. 19 illustrates a prior art contour gauge;

FIG. 20 illustrates preferred logic for an exemplary method of using a device for measuring energized electrical conductors; and

FIG. 21 illustrates a perspective view of the device of FIG. 4 being used to measure an electrical conductor.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

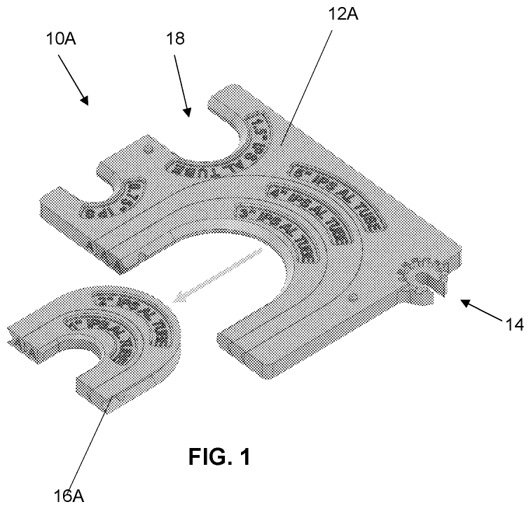

Referring to FIG. 1, an exemplary CSVT 10A is shown. The CSVT 10A may include a body 12A and nested inserts (e.g., 16A). Each nested insert (e.g., 16A) may be configured to be securely fastened to a remainder of the body. For example, one or more protrusions and/or depressions in the insert 16A may be received by one or more protrusions and/or depressions in a corresponding slot to secure the insert 16A at the slot. The surface area of the body 12A, and the diameter of exposed slots 18 of the CSVT 10A may be adjusted by way of adding and/or removing inserts to the device 10A. It will be apparent to one of ordinary skill in the art that various techniques may be provided for securing inserts at slots of an exemplary CSVT. The slots may be substantially U-shaped. The body of the insert 16A may also be substantially U-shaped. One or more inserts may be attached to one another before being attached to the body 12A, although such is not required.

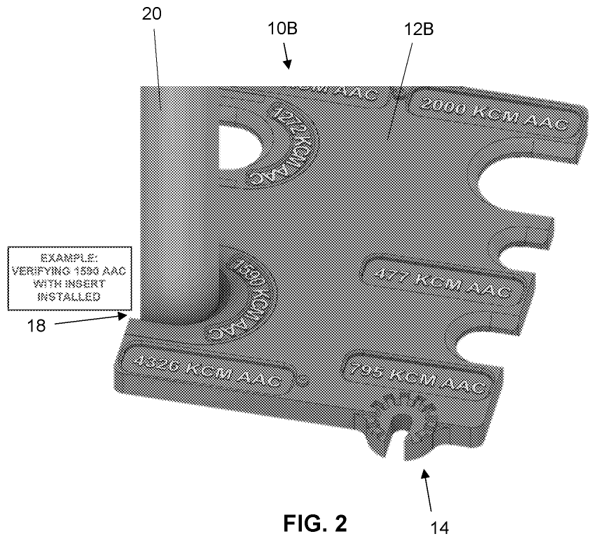

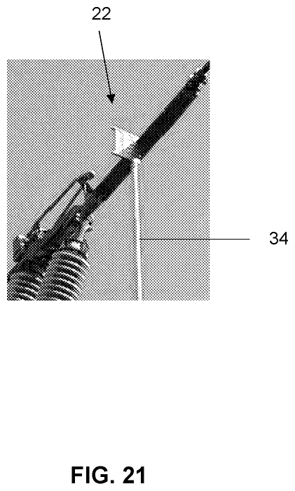

The plurality of slots 18 at the body 12A may each be capable of receiving tubular aluminum, and/or another conductor material. An operator/inspector may securely mount the CSVT 10A to a live-line tool (e.g., hot stick 34 in FIG. 21) at a connector 14 of the CSVT 10A to ensure stable operation of the CSVT during measurement of a conductor (e.g., conductor 20 in FIG. 2). The live-line tool and connector 14 may be secured to one another by way of engagement of corresponding protrusions and depressions with one another. A 90-degree adaptor may be provided to promote securement of the live-line tool to the CSVT 10A. Prior to measurement of the conductor, the operator may refer to a design print providing specified conductor sizes for compliance verification. Based on this, the operator may select one of a plurality of slots 18 to position at the conductor to measure the conductor for compliance verification. When the conductor fully fits into the slot 18, the operator may confirm that the conductor diameter and the slot diameter are the same, or are at least substantially the same. Other types and/or kinds of tools may be utilized in other embodiments.

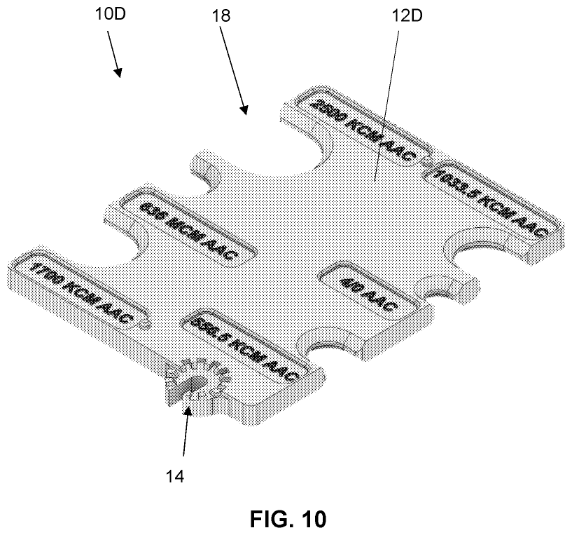

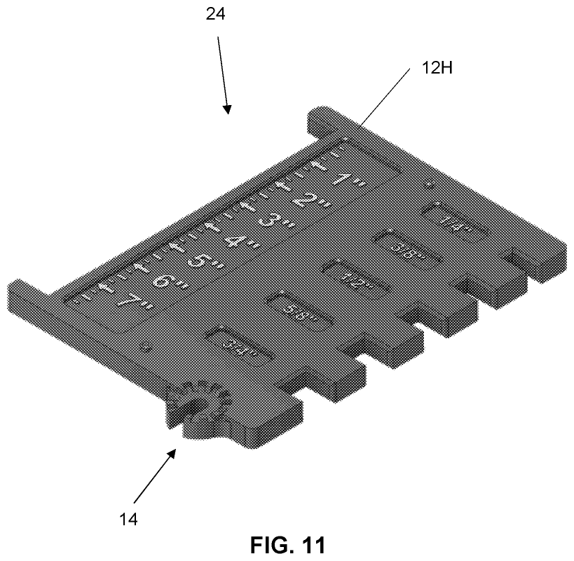

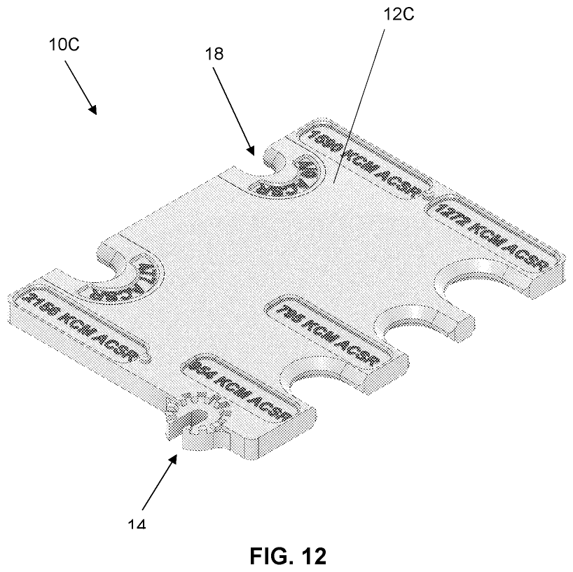

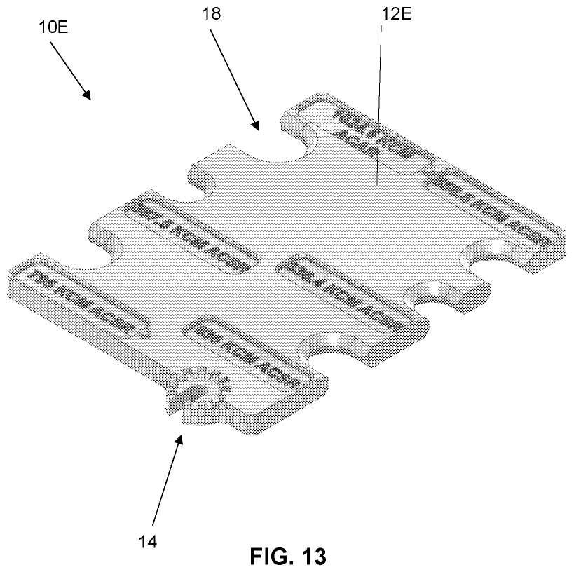

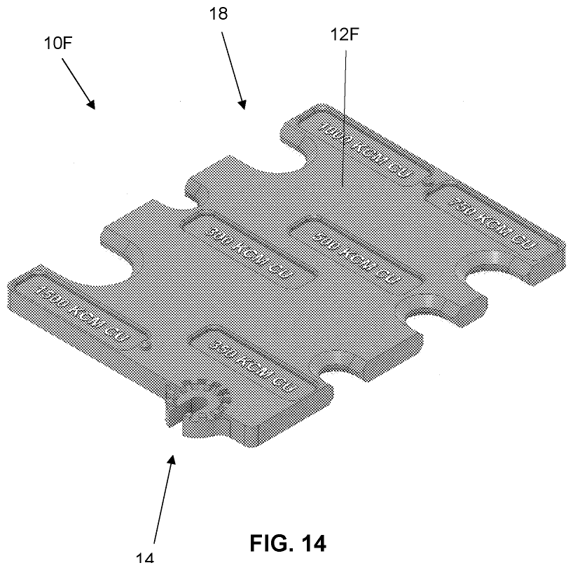

For example, referring to FIG. 2, an operator may verify the size of a conductor 20 (e.g., 1590 AAC) using a CSVT 10B (having a body 12B and connector 14) by positioning a slot 18 defined by an insert at the conductor 20. FIGS. 2-15 demonstrate that an exemplary CSVT 10A-G (having a connector 14) may include various body 12A-G dimensions, and may include various slot 18 dimensions. An exemplary CSVT is not limited to a particular color, size, number of inserts, dimensions thereof, or shape thereof. Text may be included at the surface of the CSVT to, for example, indicate slot dimensions, but such is not required. An exemplary CSVT is not limited to a particular text size, font and/or location.

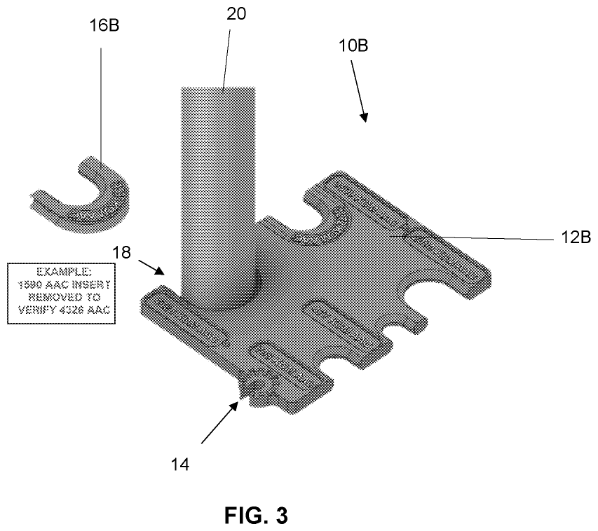

Referring to FIG. 3, one or more nested inserts (e.g., 16B) may be removed from the body 12B of the CSVT 10B to increase slot 18 diameter (in this particular example, for measuring 4326 AAC). A user may quickly add and/or remove an insert to obtain various slot sizes within a short amount of time (e.g., promoting flexibility with respect to measuring conductor sizes across a broad range without the need for additional tools). The slot configuration of the body 12B may be selected to accurately evaluate the size of various conductors in an energized substation.

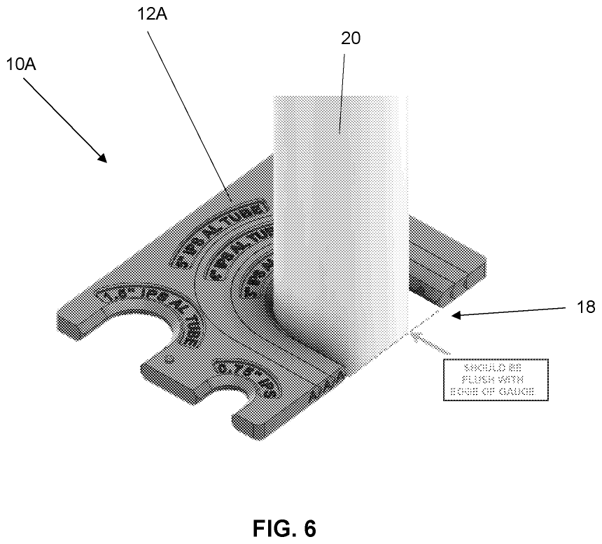

Referring to FIG. 6 (illustrating a CSVT 10A measuring aluminum tubing 20, wherein the tubing being flush with the edge of the CSVT 10A indicates that the tubing diameter is the correct 3 inches). It is preferred that the operator carefully positions the slot 18 over the conductor 20 and then observes the device 10A to ensure that the conductor 20 is flush with the outer edge of the CSVT 10A. When the operator is able to visually confirm that the conductor 20 is flush with the outer edge of the CSVT 10A and spans the diameter of the slot, the operator may conclude that the conductor 20 is properly sized and seated. Tight tolerances may be permitted to verify conductor sizes with a high level of accuracy.

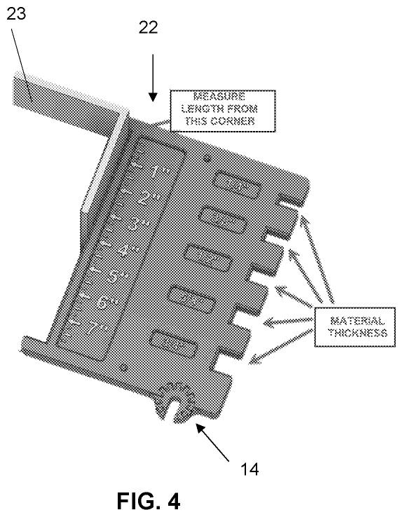

Referring to FIG. 4 (illustrating an alternative CSVT 22 measuring an alternative conductor 23), an exemplary CSVT 22 may be employed for measuring the thickness and length of an angular bus/flat stock. In this particular example, the CSVT 22 provides the ability to measure material lengths from a quarter inch up to eight inches, where increments are a quarter inch. The CSVT 22 also provides the ability to measure material thicknesses from a quarter inch up to 3 quarters of an inch. In other embodiments, the measurement unit system, range and/or increments may be lower or higher.

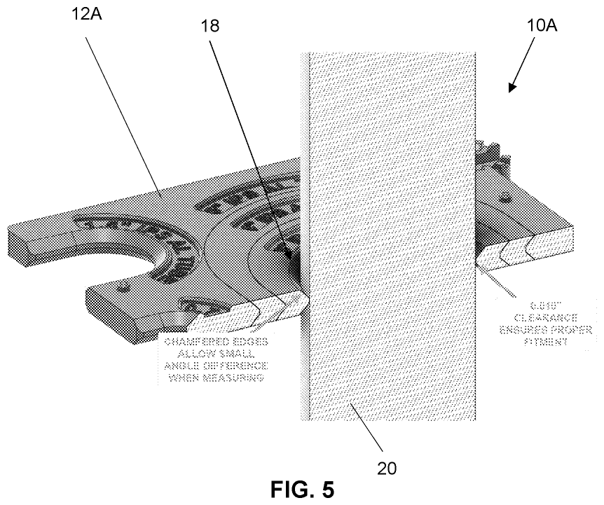

Referring to FIG. 5, a cross section of the CSVT 10A of FIG. 1 is shown while in exemplary use. The CSVT 10A may include chamfered edges and ten thousandths tolerance for fitment. The chamfered edges may promote ease of CSVT 10A movement (e.g., around conductors in tight spaces). The slots 18 may be nested, allowing users to quickly switch between different slot sizes by introducing various different inserts to the device 10A. Different inserts may be integrated at the device 10A without the need for a tool to perform the integration. The chamfered inner edges of an exemplary CSVT may facilitate smooth sliding of the CSVT onto and off of a conductor.

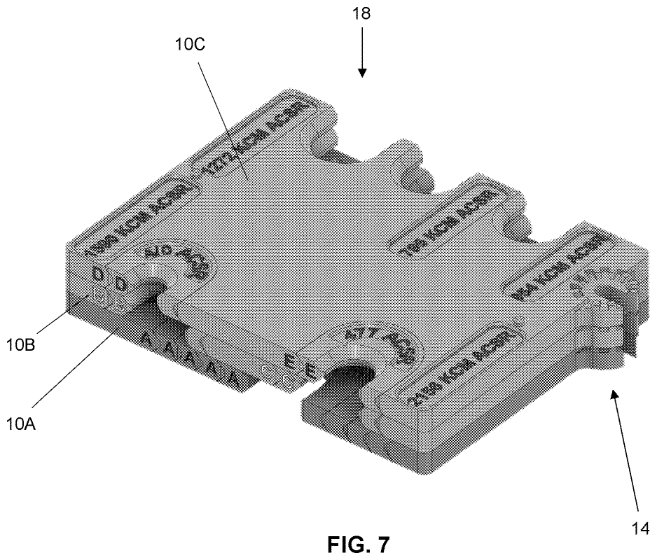

Referring to FIG. 7, indicators (e.g., letters) may be provided at the CSVTs 10A-C (e.g., to promote proper insert alignment). Various different CSVTs (e.g., 10A-C) collectively accommodating a broad range of conductor sizes may be color coded to allow for quick user identification of the appropriate slots for a particular conductor. Each nested insert may be distinctly marked with letter designations, ensuring that users can easily verify that each insert is placed in the correct slot. The CSVTs 10A-C may be stacked on one another. The aforementioned CSVT features may optimize transportation or storage of the CSVTs 10A-C, streamline the conductor measurement process, enhance user confidence in conductor measurement effectiveness (e.g., by allowing operators to quickly ascertain the correct CSVT configuration for their specific measurement needs), some combination thereof, or the like.

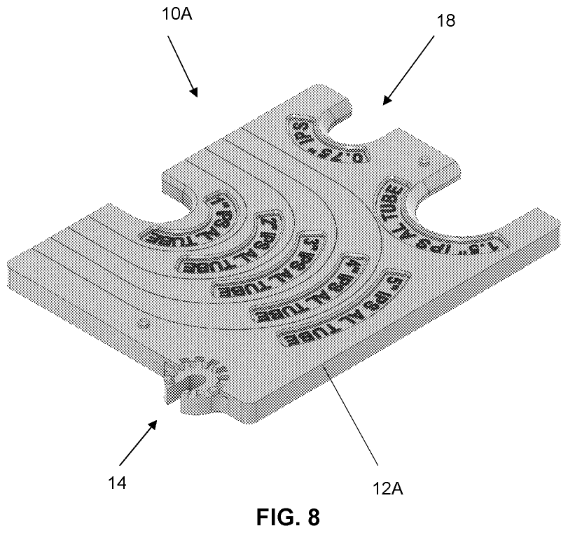

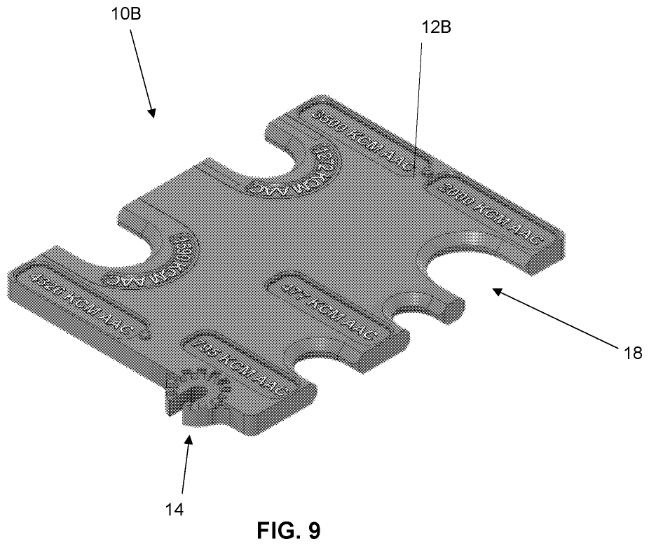

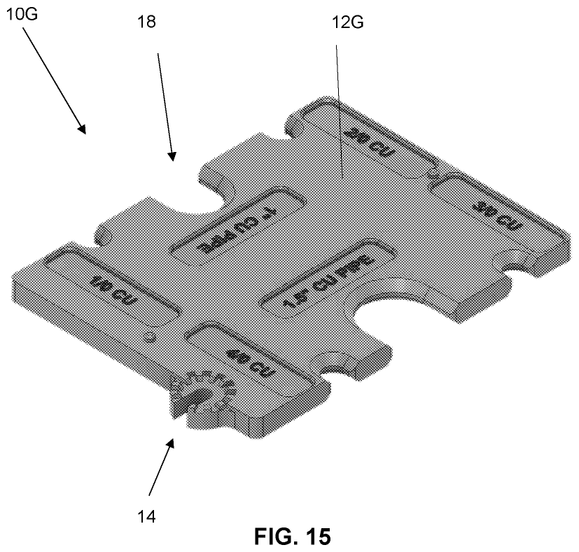

Referring to FIGS. 9-15, various exemplary CSVTs 10B-G and 24 (each having a connector 14) are shown. CSVTs 10B and D may be used to measure various different AAC conductors, by way of example. CSVT 24 may be used to measure an angle and flat stock conductor, by way of example. CSVTs 10C and E may be used to measure an ACSR conductor, by way of example. CSVTs 10F and G may be used to measure a copper conductor, by way of example. An exemplary CSVT for measuring aluminum conductors (e.g., AAC, ACSR) may allow for at least 36 slot options, although such is not required. An exemplary CSVT for measuring copper conductors may allow for at least 36 slot options (e.g., allowing a user to assess a wide range of wire sizes), although such is not required. Referring to FIGS. 8 and 15, CSVTs 10A and 10G may allow for measurement of aluminum tubing conductors. An exemplary CSVT for measuring aluminum tubing conductors may allow for at least 9 slot options (e.g., to accommodate a wide range of different tubular bus sizes). An exemplary CSVT for measuring copper tubing may also allow for at least 9 slot options (e.g., to accommodate a wide range of different tubular bus sizes). These numbers are exemplary and not intended to be limiting.

Referring to FIGS. 1-15 and 20-21, an exemplary CSVT is configured to be user friendly. An exemplary device (e.g., 10A-G, 22, 24) may be securely mounted to a live-line tool at a connector of the device. Current may be restricted from traveling from the conductor towards the operator, enabling users to accurately measure conductor sizes without the need to de-energize the electrical system. Each CSVT slot may be specifically calibrated to accommodate a specific conductor size.

The CSVT may be constructed from PETG (Polyethylene Terephthalate Glycol) filament, a non-conductive or at least substantially non-conductive material (e.g., reducing the risk of accidental electrical contact) known for its stability and strength (e.g., it is resistant to warping, shrinking, and/or other deformation under normal use). PETG may promote device durability, safety, and ease of 3D-printing. This choice of material may ensure that an exemplary device is safe for use in environments where electrical conductivity would otherwise pose a risk. The stability of PETG may ensure that an exemplary CSVT maintains its accuracy over time. PETG is also UV resistant, making it suitable for outdoor use and/or applications where UV is highly prevalent. PETG is preferably stored in a dry, cool environment prior to printing to prevent moisture absorption, which may otherwise affect print quality.

The CSVT may be configured to allow for various tools to be integrated thereto, whether or not in current production (e.g., allowing for a broad range of applicability for the CSVT for current and future projects). The CSVT may be 3D-printed, and may be compact in size (e.g., to allow for quick adjustments on-site, to promote ease of maintenance and inspections, some combination thereof, or the like). Autodesk Fusion 360 may be used to specify device configurations for 3D-printing of the CSVT. Certain alternative CSVTs may be formed with PLA (Polylactic Acid) and/or ABS (Acrylonitrile Butadiene Styrene).

Various 3D printers may be employed to form an exemplary CSVT device. In a preferred embodiment, a 3D printer compatible with PETG filament is employed. It is preferred that after printing, an exemplary device and/or components thereof are carefully cleaned, particularly where there is support material and/or rough edges. It is also preferred that after printing, a user ensures that the nested inserts are able to be engaged and/or disengaged correctly with an exemplary device. Thereafter, a user may securely attach a live line tool to the CSVT (e.g., live line tool 34 in FIG. 21 may be attached to CSVT 22) by affixing a portion of the live line tool or a mechanical connection linked thereto to the connector 14 of the CSVT. Using the live line tool (e.g., 34), an operator (e.g., standing on the ground below the conductor in an energized environment) may position a slot 18 of the CSVT at the conductor 20. Before doing so, the operator may predict which slot 18 corresponds to the conductor 20 (e.g., based on consulting reference material). Preferably, the operator will ensure that the conductor 20 is flush against an outer edge of the CSVT to accurately determine the size of the conductor 20.

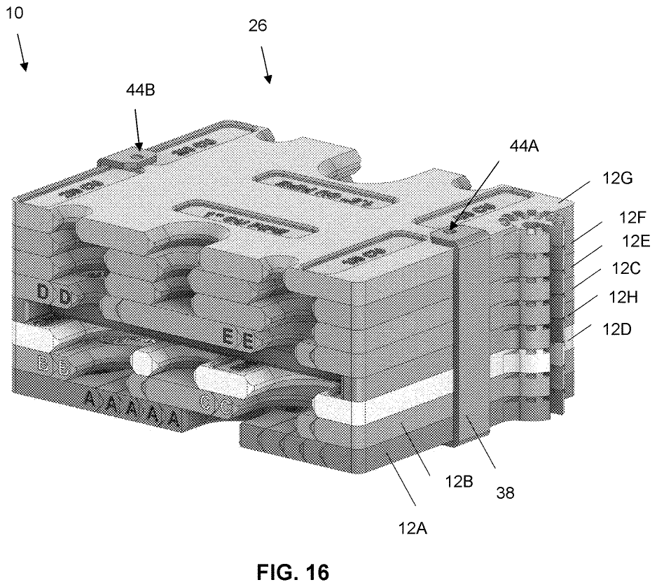

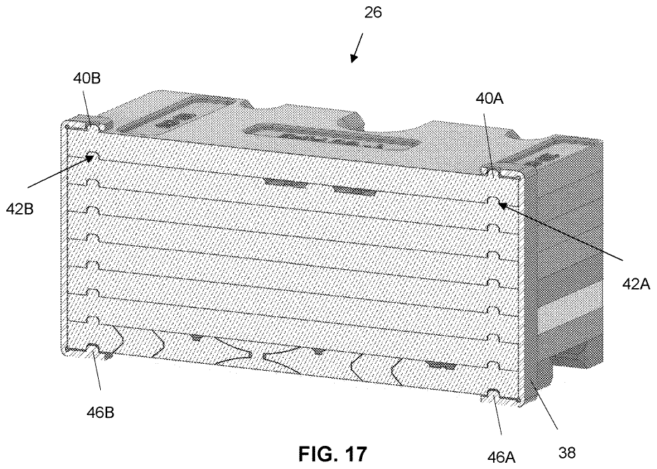

The CSVTs 10 may include a single body 12, or multiple bodies (e.g., 12A-12H). For example, referring particularly to FIG. 16, an exemplary stack 26 of bodies 12A-12H may include one or more retainer clips 38 to secure the bodies 12A-12H of the CSVT 10 with respect to one another for organization, storage and/or transportation (e.g., to and from verification sites). The retainer clips 38 may specifically comprise two retainer clips configured to engage with alignment pins to hold the bodies 12A-12H together. The stack 26 may include eight different bodies 12A-12H, although various number, type, and/or arrangement of bodies 12A-12H may be utilized. Each of the eight different bodies 12A-12H in this particular embodiment are capable of differentiating between at least thirty-six different standard conductor sizes, nine tubular bus sizes, and an 8-inch length tool. As each body 12A-12H may perform a variety of different functions, an operator may utilize bodies 12A-12H from the stack 26 to perform various conductor measurement tasks without the need for additional tools. The stack 26 may be carried with minimal effort, and may require little storage space to be stored (which, for example, may benefit field personnel tasked with storing and transporting the CSVTs). FIG. 17 illustrates a cross sectional view of the stack 26, wherein the cross section here is shown at the retainer clips 38. Two alignment pins 40A, 40B may be located on the front face of some, preferably all, of the bodies 12A-12H of the stack 26, along with corresponding inverse pin holes 42A, 42B on the rear of some, preferably all, of the bodies 12A-12H of the stack 26. This may allow for alignment of the stacked bodies 12A-12H and/or engagement of the retaining clips 38.

The retaining clips 38 may include holes 44A, 44B for engaging the pins 40A, 40B of an uppermost one of the bodies 12 in the stack 26, and pins 46A, 46B for engaging the pin holes 42A, 42B of a lowermost one of the bodies 12 in the stack 26. This may allow the bodies 12A-12H be secured in a stack 26 in proper exterior alignment. Various number, size, shape, and/or arrangement of such pins 40A, 40B, 46A, 46B, and/or pin holes 42A, 42B, 44A, 44B, such as in the form of various size and/or shape protrusions and mating depressions may be utilized.

The CSVTs 10 may be part of a system, such as optionally in combination with one or more poles or other devices for manipulating the CSVTs 10A-10C to electrical conductors for measurement, such as at elevated and/or otherwise difficult to reach locations.

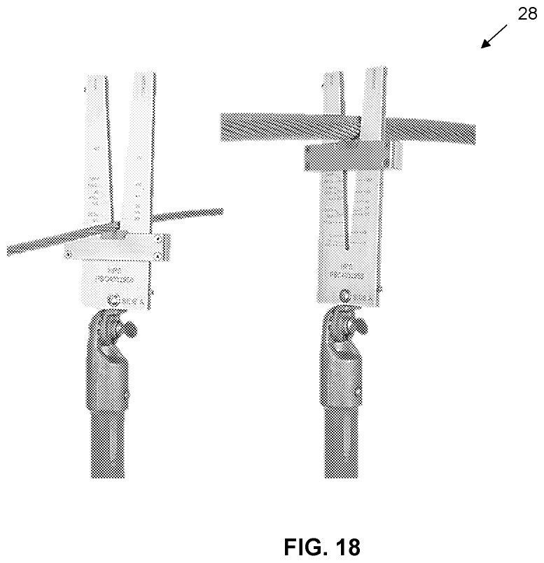

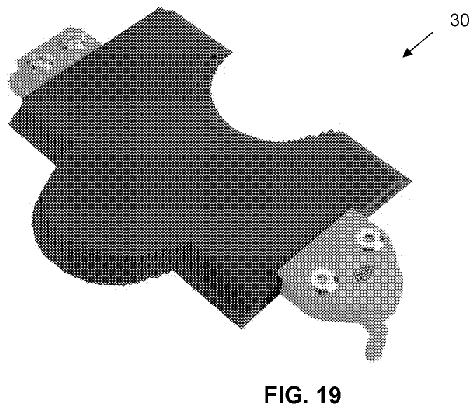

FIGS. 18-19 show known measurement devices. Specifically, FIG. 19 illustrates a contour gauge 30, and FIG. 18 illustrates a conductor gauge 28. With the contour gauge, there is no live-line tool attachment, there is higher margin for error, and a secondary measurement is required. Referring to FIGS. 1, 18-19, an exemplary CSVT (e.g., 10A) offers significant improvements over the contour gauge 30. For example, there is no secondary measurements required with the exemplary CSVT. A user may directly ascertain conductor sizes without needing to make additional calculations or adaptations, which minimizes the potential for inaccuracies. The exemplary CSVT (e.g., 10A) is far more accurate than the contour gauge 30, and provides higher adaptability.

With the conductor gauge 28, there is a limit on the size of conductors that may be measured, and the risk of electrical shock is much higher than that with an exemplary CSVT (e.g., 10A). An exemplary CSVT allows for a broader range of conductors, including larger conductors, to be verified. An exemplary CSVT also does not require a secondary determination. Furthermore, an exemplary CSVT significantly enhances safety compared to known alternatives, because, e.g., the exemplary CSVT prevents electrical current from being transmitted to an operator. Thus, an exemplary CSVT allows verification measurements to be taken while the BES remains energized.

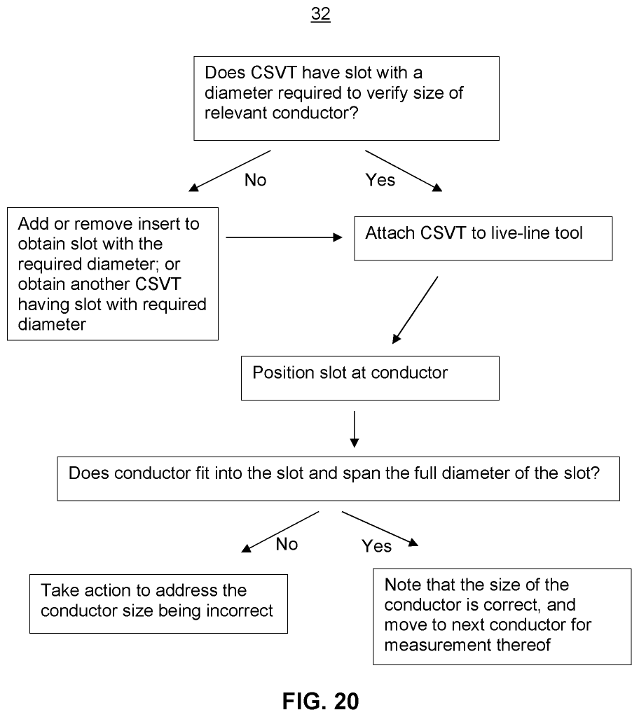

FIG. 20 illustrates preferred logic 32 for an exemplary method of using a device for measuring energized electrical conductors. FIG. 21 illustrates a field application of an exemplary device 22 linked to a live line tool 34. In the FIG. 21 embodiment, the inspector may remain on the ground while positioning the CSVT at the conductor to measure the dimensions of the conductor, even when the conductor remains energized.

Unless otherwise indicated herein, the term “substantially” means at least 90% of the stated feature or value. Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A conductor size verification device, the device comprising:
a body, wherein the body is solid, and at least substantially non-conductive;
a slot provided in the body and comprising an opening in a surface of the body shaped to receive a conductive object to permit a user to measure a dimension of the conductive object; and
a connector provided in the body and comprising at least one depression, protrusion, or both at the surface of the body, wherein the at least one depression, protrusion, or both are shaped to allow attachment of the body to a live-line tool to permit the user to reposition the slot from a first position away from the conductive object to a second position in contact with the conductive object.

2. The device of claim 1, wherein the at least one depression, protrusion, or both of the connector includes a plurality of protrusions extending upward from a shelf defining a u-shaped depression in the body.

3. The device of claim 1, further comprising a solid, substantially non-conductive first insert shaped to be removably secured in the slot of the body, wherein the first insert includes an insert slot configured to contact the conductive object to permit the user to measure the dimension of the conductive object.

4. The device of claim 3, wherein the first insert includes a depression configured to receive a protrusion at least partially defining the slot of the body to secure the first insert to the body.

5. The device of claim 3, further comprising a solid, substantially non-conductive second insert shaped to be removably secured in the insert slot of the first insert, wherein the second insert includes an insert slot configured to contact the conductive object to permit the user to measure the dimension of the conductive object.

6. The device of claim 3, wherein the first insert is substantially u-shaped.

7. The device of claim 3, wherein the slot of the body includes a chamfered edge at least partially defining the slot of the body, and the first insert includes a chamfered edge at least partially defining the insert slot of the first insert.

8. The device of claim 1, further comprising one or more indicators at the surface of the body, the one or more indicators permitting a user to measure the dimension of the conductive object when the slot is in the second position.

9. The device of claim 1, wherein the slot comprises a plurality of slots.

10. The device of claim 9, wherein each slot of the plurality of slots is u-shaped.

11. The device of claim 1, wherein the slot is substantially u-shaped.

12. The device of claim 1, wherein the conductive object is cylindrical in shape, and the measured dimension is the diameter of the conductive object.

13. The device of claim 1, wherein the body comprises at least one of Polyethylene Terephthalate Glycol (PETG), Polylactic Acid (PLA) and Acrylonitrile Butadiene Styrene (ABS).

14. A system for measuring an energized electrical conductor, the system comprising:
the conductor size verification device of claim 1; and
a second one of the conductor size verification device of claim 1 (“second conductor size verification device”), where the slot of the second conductor size verification device is of a different size from the slot of the conductor size verification device to receive the conductive object to measure the dimension of the conductive object;
wherein the conductor size verification device of claim 1 is further configured to be securely stacked onto the second conductor size verification device in a nesting arrangement.

15. The system of claim 14, further comprising a retainer clip configured to contact the conductor size verification device and the second conductor size verification device to frictionally engage the conductor size verification device and the second conductor size verification device in the nesting arrangement for storage.

16. The system of claim 15, wherein the retainer clip further comprises an aperture shaped to receive a portion of the conductor size verification device to secure the retainer clip relative to the conductor size verification device.

17. The system of claim 14, wherein the conductor size verification device further comprises a depression at a bottom surface thereof shaped to receive a protrusion at a top surface of the second conductor size verification device to provide the nesting arrangement between the conductor size verification device and the second conductor size verification device for storage.

18. A method for measuring an energized electrical conductor, the method comprising:
attaching the conductor size verification device of claim 1 to a live-line tool; and
verifying a diameter of a conductive object when the slot spans the diameter of the conductive object.

19. The method of claim 18, further comprising providing a solid, substantially non-conductive first insert shaped to be removably secured in the slot of the body, wherein the first insert includes an insert slot configured to contact the conductive object to permit the user to measure the dimension of the conductive object, and removably securing the first insert in the slot of the body when a diameter of the slot of the body is greater than the diameter of the conductive object.

20. The method of claim 19, further comprising providing a solid, substantially non-conductive second insert shaped to be removably secured in the insert slot of the first insert, wherein the second insert includes an insert slot configured to contact the conductive object to permit the user to measure the dimension of the conductive object, and removably securing the second insert in the insert slot of the first insert when a diameter of the insert slot of the first insert is greater than the diameter of the conductive object.
